(19) United States
(12) Patent Application Publication
(10) Pub. No.: US 2008/0250383 A1
(43) Pub. Date: Oct. 9, 2008

(54) Method for designing mask pattern and method for manufacturing semiconductor device

(76) Inventors: Toshihiko Tanaka, Tokyo (JP); Tsuneo Terasawa, Tokyo (JP); Nobuyuki Yoshioka, Tokyo (JP); Tetsuya Higuchi, Tsukuba (JP); Hidenori Sakanashi, Tsukuba (JP); Hirokazu Nosato, Tsukuba (JP); Masahiro Murakawa, Tsukuba (JP)

Correspondence Address: REED SMITH LLP, 3110 Fairview Park Drive, Suite 1400, Falls Church, VA, 22042, US

(21) Appl. No.: 11/526,820

(22) Filed: Sep. 26, 2006

(30) Foreign Application Priority Data
Sep. 26, 2005 (JP) 2005-277331

(51) Int. Cl. G06F 17/50

(52) U.S. Cl. 716/21

(57) ABSTRACT

A mask pattern designing method capable of achieving the reduction in the increasing OPC processing time, shortening the manufacture TAT of a semiconductor device, and achieving the cost reduction is provided. An OPC (optical proximity correction) process at the time when a cell is singularly arranged is performed to a cell library pattern which forms a basic structure of a semiconductor circuit pattern in advance, and a semiconductor chip is produced using the cell library pattern to which the OPC process has been performed. At this time, since the cell library pattern which has been OPC-processed in advance is influenced by the cell library patterns around it, the correction process thereof is performed to the end portions of the patterns near the cell boundary. As particularly effective OPC correction means, the genetic algorithm is used.

### CROSS-REFERENCE TO RELATED APPLICATION

The present application claims priority from Japanese Patent Application No. JP 2005-277331 filed on Sep. 26, 2005, the content of which is hereby incorporated by reference into this application.

### TECHNICAL FIELD OF THE INVENTION

The present invention relates to a manufacturing technology of a semiconductor device. In particular, it relates to a technology effectively applied to a mask pattern designing process for forming a pattern smaller than an exposure wavelength in optical lithography.

### BACKGROUND OF THE INVENTION

Semiconductor devices can be mass-produced by repeating photolithography steps of irradiating exposure light to a mask which is a master plate in which a circuit pattern is written to transfer the pattern onto a semiconductor substrate (hereinafter, referred to as wafer) via a reduction optical system. In recent years, it has been required to form a pattern having a dimension smaller than an exposure wavelength in optical lithography according to advance in miniaturization of a semiconductor device. In such a pattern transfer of a fine region, however, since influence of light diffraction significantly appears, a contour of a mask pattern is not formed on a wafer as it is, which results in considerable degradation in shape accuracy such as rounding of a corner of the pattern or shortening of a length of the pattern. Therefore, the mask pattern is designed with the process of the reverse-correction so that this deterioration may become small. The process is called “optical proximity correction” (hereinafter, abbreviated as “OPC”).

In a conventional OPC, the correction is performed with a rule base or a model base using optical simulation, while taking into account the influence of a shape of a figure and its surrounding pattern for each figure in a mask pattern. Japanese Patent Application Laid-Open Publication No. 2002-303964 (Patent Document 3) describes a rule base OPC that performs graphical operation according to a line width and a space width between adjacent lines to conduct pattern correction. Also, Japanese Patent Application Laid-Open Publication No. 2001-281836 (Patent Document 2) describes a rule base OPC that performs line segment vectorization process and line segment sorting process to calculate a line width and a space width and performs pattern correction with reference to a correction table using hash function. Further, Japanese Patent Application Laid-Open Publication No. 2004-61720 (Patent Document 4) describes a model base OPC that takes in a process effect through a transfer experiment.

In the model base using optical simulator, a mask pattern is continuously changed until a desired transfer pattern is obtained, and various methods to acquire the desired mask pattern have been proposed. For example, a so-called sequential improving process has been known in which, when an optical image is partially thick, the corresponding pattern is made thin, and when the optical image is thin, it is made thick, and the optical image is re-calculated in such a state, thereby gradually approaching its desired shape. A method of gradually approaching its desired shape by using a genetic algorithm has also been proposed. In the method using a genetic algorithm, a pattern is divided into a plurality of line segments and displacement of the line segments is assigned as a displacement code. Then, the displacement code is regarded as a chromosome to compute evolution of inheritance, thereby gradually approaching its desired optical image. An optimization method for the OPC using the genetic algorithm is described in Japanese Patent No. 3512954 (Patent Document 1).

Japanese Patent Application Laid-Open Publication No. 2002-328457 (Patent Document 5) describes a method where figure is changed for each portion of a mask layout instead of the whole mask layout. In the procedure of the method, first, regarding each of target cells to be corrected included in design layout data, an environment profile expressed in a specific form is determined according to whether or not another figure is present around the target cell. Then, a replacement cell name which is a name of a correction pattern to be replaced in accordance with the determined environment profile is read with reference to a cell replacement table, and corrected layout data is produced. Finally, a correction pattern corresponding to the read replacement cell name is taken from a cell library to produce mask data representing the completion of correction.

### SUMMARY OF THE INVENTION

The inventors of the present invention have examined the mask pattern designing technology described above and have found the following facts.

In the method described in Patent Document 5, for example, regarding all environment profiles which can be assumed for the target cells to be corrected, it is necessary to determine optimal correction patterns to be replaced, give replacement cell names to respective correction patterns and store the environment profiles and replacement cell names associated with each other in a cell replacement table in advance. Therefore, such a problem arises that cost required for advance preparation increases and much storage region is required.

The genetic algorithm (hereinafter, also referred to as “GA”) is a search technique utilizing a population genetics model, and it is known to have such an excellent performance to find good solution quickly without depending on a target problem. As the reference document for the GA, there is “Genetic Algorithms in Search, Optimization, and Machine Learning” by David E. Goldberg, published by ADDISON-WESLEY PUBLISHING COMPANY, INC. in 1989 (Non-Patent Document 1), for example.

In the GA, solution candidates for the search problem are expressed using a bit string called “chromosome”, and character string operation is preformed to a population constituted of a plurality of chromosomes, thereby causing the battle for survival. Respective chromosomes are evaluated by an objective function which is a search problem itself, and the result of the evaluation is calculated as fitness which is a scalar value. A chromosome having high fitness is given many opportunities for leaving its descendants. Further, a new chromosome is produced by performing crossover between chromosomes within a population, and mutation. By repeating such a process, a chromosome having higher fitness is produced, and chromosome having the highest fitness constitutes a final solution.

FIG. 1 is a flowchart showing the most fundamental calculation procedure in the GA. An object and an outline of each process are as follows:

Initialization (step S02): A plurality of chromosomes as solution candidates are generated at random and a population is formed. An optimization problem to be solved is expressed as an evaluation function returning a scalar value.

Evaluation of chromosomes (step S03): Chromosomes are evaluated using the evaluation function and fitness of each chromosome is calculated.

Generation of next-generation population (step S04): A chromosome with higher fitness is given more opportunities to leave descendants by using genetic operation (gene selection, crossover, and mutation).

Search termination criterion determination (step S05): Evaluation of chromosomes and generation of next-generation population are repeated until given conditions are satisfied.

Outline of the genetic algorithm will be described below with reference to FIG. 1.

In the “initialization” in step S02, “definition of chromosome expression”, “determination of evaluation function”, and “generation of initial chromosome population” are performed.

In the “definition of chromosome expression”, contents of data and form thereof to be transmitted from a chromosome of a parent to a chromosome of a descendant at the generation alternation are defined. FIG. 2 shows one example of a chromosome. In FIG. 2, respective elements xi (i=1, 2, . . . , D) of D-dimensional variable vectors X=(X1, X2, . . . , XD) expressing the points in a solution space for a target optimization problem are expressed using a string constituted of M symbols Ai (i=1, 2, . . . , M), which is regarded as a chromosome constituted of D×M genes. A set of certain integers, actual values in a certain range, a symbol string, or the like can be used as values Ai of genes according to the property of a problem to be solved. FIG. 2 shows one example where, regarding one of solution candidates of an optimization problem corresponding to five dimensions or five variables (namely, D=5), each variable is expressed using four symbols (namely, M=4) of two kinds (0, 1). A gene string thus symbolized is a chromosome.

Next, in “determination of evaluation function”, a calculation method of a fitness representing a degree of adaptation of each chromosome to environment is defined. At that time, such a design is adopted that fitness of a chromosome corresponding to a variable vector excellent as a solution of an optimization problem to be solved becomes higher.

In “generation of initial chromosome population”, N chromosomes are generated according to a rule determined in “definition of chromosome expression” at random. This is because property of the optimization problem to be solved is unclear and kind of a superior chromosome is unclear at all. However, when there is any priori knowledge regarding the problem, the accuracy and search speed can be improved in some cases by generating a chromosome population centering on a region where fitness is expected to be high in a search space.

In “evaluation of chromosomes” in step S03, fitness of each chromosome in the population is calculated based upon the method defined in the “determination of evaluation function” step.

In “generation of next-generation population” in step S04, the genetic operation is performed to the chromosome population based upon the fitness of each chromosome to generate a chromosome population of next generation. The major procedures of the genetic operation include gene selection, crossover, mutation, and the like, which are collectively called “genetic operation”.

In the “selection” step, a chromosome with high fitness is extracted from a current generation chromosome population and is left for the next-generation population, and on the other hand, chromosomes with low fitness are eliminated.

In the “crossover” step, chromosome pairs are selected at random from a population of chromosomes extracted by the selection with a predetermined probability to recombine some of the genes of the chromosomes, thereby producing new chromosomes.

In the “mutation” step, chromosomes are selected at random from a population of chromosomes extracted by the selection with a predetermined probability and genes are changed with a predetermined probability. Note that a probability of occurrence of mutation is called “mutation rate”.

In the “search termination criterion determination” in step S05, it is determined whether or not the next-generation chromosome population satisfies a criterion for terminating the search. When the criterion is satisfied, the search is terminated, and the chromosome with the highest fitness at this time in the chromosome population is determined as a solution for the optimization problem to be obtained. When the termination criterion is not satisfied, the process is returned back to the “evaluation of chromosomes” step, where the search is continued. The termination criterion of the search process depends on characteristics of the optimization problem to be solved but it typically includes the following conditions.

(a) The maximum fitness in a chromosome population exceeds a certain threshold.

(b) An average fitness of chromosomes in a whole chromosome population exceeds a certain threshold.

(c) A generation where an increase rate of fitness in a chromosome population is equal to or lower than a certain threshold continues for a fixed period or more.

(d) The number of generation alternations reaches a predetermined number of times.

In the conventional method utilizing the above-described genetic algorithm, OPC is performed to all figures of a mask defining a circuit pattern of a semiconductor chip if necessary. Therefore, according to increase of the number of figures due to miniaturization, a processing time for OPC significantly increases. In an actual case, several tens hours are required for a 90 nm node device. Also, due to the reduction of exposure contrast caused by forming a pattern at an extreme resolution for the exposure, OPC becomes more complicated and more figures are required in the case of further miniaturization. A time required for producing the mask pattern of a 65 nm node device extends over several days in some case. On the other hand, since a product cycle of a semiconductor device becomes short, the reduction of the OPC processing time is an extremely object to be achieved.

Increase of the OPC processing time deteriorates a manufacture TAT (Turn Around Time) of a semiconductor device including a mask pattern generation, and it also causes increase in cost.

In view of these circumstances, an object of the present invention is to provide a mask pattern designing technology comprising an OPC process which can achieve the reduction in an increasing OPC processing time, reduce a manufacture TAT for a semiconductor device, and reduce the cost.

Another object of the present invention is to provide a manufacturing technology of an electronic circuit device and a semiconductor device capable of generating the mask pattern within a practical time period to reduce a manufacturing period.

The above and other objects and novel characteristics of the present invention will be apparent from the description of this specification and the accompanying drawings.

The typical ones of the inventions disclosed in this application will be briefly described as follows.

The OPC process at the time when a cell is singularly arranged is performed for a cell library pattern which forms a basic configuration of a semiconductor circuit pattern in advance, and a semiconductor chip is manufactured using the cell library pattern subjected to the OPC process. At this time, since the cell library pattern subjected to the OPC process in advance is influenced by a cell library pattern positioned around the OPC-processed cell library pattern, it is necessary to perform correction process (optimization process). This correction process is performed for end portions of patterns around the boundary between cells. Representative corrections include the correction of a pattern length, the adjustment of width and length of a hammer head, the correction of serif size, and others.

Further, as particularly effective OPC correction means, the genetic algorithm is used. Since there are several hundred types of cell library patterns, the number of combinations with the surrounding cell library patterns is enormous. The correction method using a correction table based on the combinations with the surrounding cell library patterns is not practical because of its processing time and management complexity. An optimization technique such as the genetic algorithm is excellent as a method for performing the optimization of enormous number of combinations at high speed. By utilizing such an optimization technique, the processing speed of the correction process can be increased and its processing time can be shortened compared with the conventional all-pattern OPC process. This is because GA can reduce the number of steps required to obtain its desired value and such a method is suitable for the parallel process.

The effects obtained by typical aspects of the present invention will be briefly described below.

(1) The OPC process is first performed for each cell and the OPC-processed cells are stored, and all figures on a mask are formed using the combinations of the stored cells. Then, OPC adjustment process between cells is performed for all the figures on the mask. By this means, the processing time can be significantly reduced.

(2) Since the mask pattern design for a large scale integrated circuit in a manufacturing method of a semiconductor device can be hastened and facilitated, such a significant effect that mask patterns can be produced in a short time and at low cost can be achieved.

### BRIEF DESCRIPTIONS OF THE DRAWINGS

FIG. 1 is a flowchart showing a processing procedure of a genetic algorithm examined prior to the present invention;

FIG. 2 is a diagram showing one example of expression of a chromosome used in an OPC processing method examined prior to the present invention;

FIG. 3 is a diagram showing an example of pattern arrangement of a standard cell in a first embodiment of the present invention;

FIG. 4 is a diagram showing an example of pattern arrangement illustrating a portion to be re-adjusted by OPC in a second embodiment of the present invention;

FIG. 5A is an explanatory diagram showing variables at a portion of a pattern to be re-adjusted by OPC in the second embodiment of the present invention;

FIG. 5B is an explanatory diagram showing variables at a portion of a pattern to be re-adjusted by OPC in the second embodiment of the present invention;

FIG. 5C is an explanatory diagram showing variables at a portion of a pattern to be re-adjusted by OPC in the second embodiment of the present invention;

FIG. 6 is an explanatory diagram showing variables at a hammer-head-shaped portion to be re-adjusted by OPC in the second embodiment of the present invention;

FIG. 7A is an explanatory diagram showing variables at a serif-shaped portion to be re-adjusted by OPC in the second embodiment of the present invention;

FIG. 7B is an explanatory diagram showing variables at a serif-shaped portion to be re-adjusted by OPC in the second embodiment of the present invention;

FIG. 8 is an explanatory diagram showing variables at hammer-head-shaped portions to be re-adjusted by OPC in a third embodiment of the present invention;

FIG. 9 is a diagram showing an example of a grouping of cells performed based upon a relative position in the third embodiment of the present invention; and

FIG. 10 is a flowchart showing a semiconductor device manufacturing process in a fourth embodiment of the present invention.

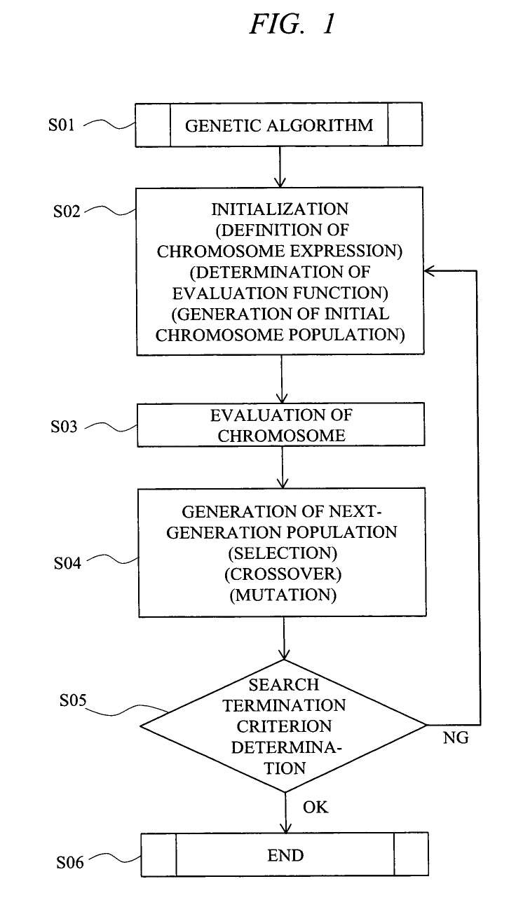

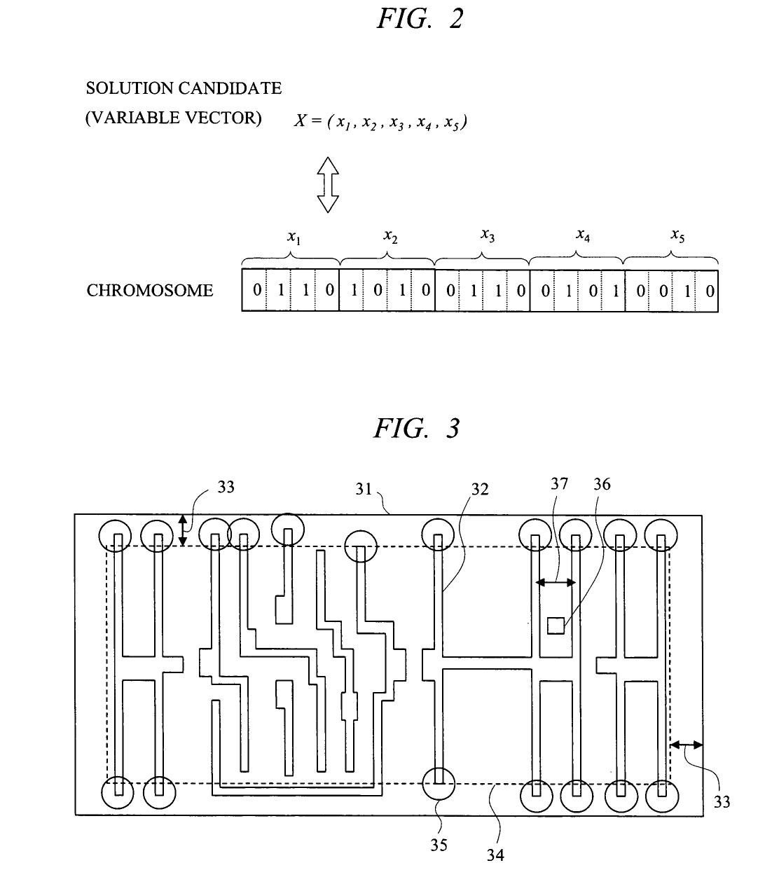

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

The mask pattern designing method according to a first embodiment of the present invention is performed using a computer or the like. The first embodiment of the present invention will be described with reference to FIG. 3. FIG. 3 shows an example where a pattern 32 is arranged in a standard cell.

As shown in FIG. 3, most of the end portions of the pattern 32 are located near a cell boundary 31, and the patterns of the end portions are deformed due to the influence from the cells arranged around them. Meanwhile, since the influence of the optical proximity effect is reduced for the patterns inside a distance 33 from the cell boundary 31, the influence from the cell patterns arranged around them is small. The layer of the pattern 32 is not particularly defined. However, it has been found out as a result of various examinations that the distance 33 where the influence reaches is 0.85 P on the basis of the minimum pattern pitch (P) 37 interposing a contact hole 36 in the case of the gate wiring pattern.

Since the influence from other cells and patterns arranged around the cell hardly reaches to an area within a re-correction boundary 34, the pattern deformation due to the proximity effect occurs from the interference between the patterns within the cell boundary 31. Therefore, the pattern deformation at the time when a cell is singularly arranged is corrected by a standard OPC technique, and the corrected cell is registered in a library so that the registered cell is referenced when the same cell as the registered cell is used. The registered cell is referenced also in the case of other products using the same cell in addition to this product.

Then, the re-correction by OPC for the pattern end portions 35 in the region between the cell boundary 31 and the re-correction boundary 34 is performed with taking into account the influence from patterns arranged around the cell. A normal OPC method such as the model base OPC can be applied to this correction method. However, a large amount of OPC re-correction process can be performed in a short time by using the genetic algorithm described later in the third embodiment. Since the core portion of the cell (portion within the boundary 34) can be repeatedly utilized without re-calculation, the OPC processing time can be shortened by almost one digit in total by this method.

### Second Embodiment

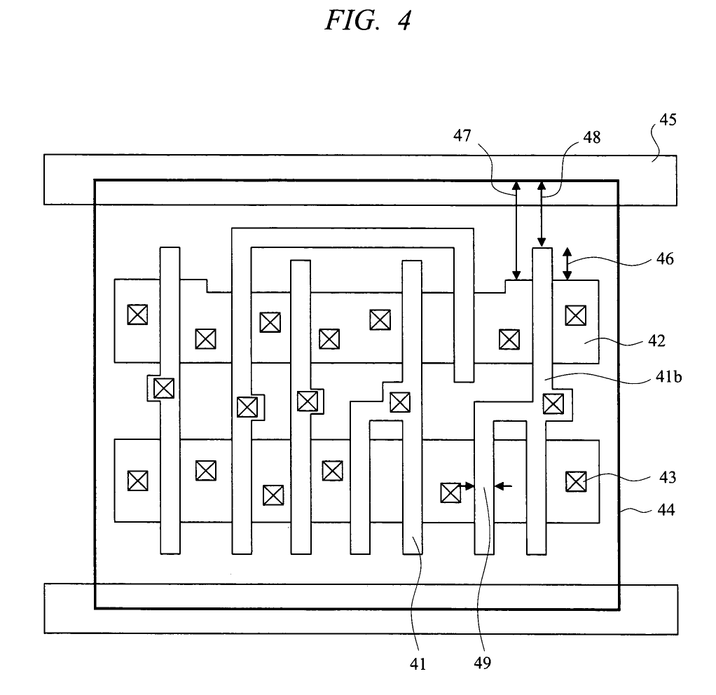

A second embodiment of the present invention will be described with reference to FIG. 4 to FIG. 7. FIG. 4 shows an example of a standard cell, in which a reference numeral 44 denotes a cell boundary. A reference numeral 41 denotes a gate wire, 42 denotes a diffusion layer, and 43 denotes a contact hole. Similar to the first embodiment, most of end portions of the gate wire are located near the cell boundary.

A gate length 49 requires the highest dimensional accuracy in a gate, but it is hardly influenced by the proximity effects of the other cells and patterns arranged around the cell other than a gate pattern 41b which is located near the periphery portion. This is because of the long distance from the external patterns and because the patterns which are arranged above and below the gate extending in a longitudinal direction and the gate length which is a width in a lateral direction are in the positional relationship where the interaction therebetween hardly occurs. The patterns arranged in a lateral direction other than the gate pattern 41b arranged closest to the periphery portion are subjected to the OPC process in a state where the positional relationship thereof has been already determined, and the gate pattern 41b arranged closest to the periphery portion functions as a kind of barrier to reduce the influence of the proximity effect from outside. The gate pattern 41b functions as a barrier particularly for an acid diffusion of a resist which influences a wide range. Further, since the gate pattern 41b at the most peripheral portion is also in contact with a cell boundary with interposing a diffusion layer including a contact therebetween, it is moderately influenced by the patterns outside the cell.

The pattern deformation of the gate wire sandwiched by the diffusion layer 42 is next important. It requires a complicated process including the connection to a contact and the pattern deforms intricately. Therefore, a complex OPC is necessary for it. Since this portion is far from the cell boundary 44, the OPC is completed by performing the optical proximity correction once for the pattern in the cell.

The process for the end portion of a gate wire is next important. This is because the transistor characteristics are deteriorated if a predetermined amount of the projection 46 from the diffusion layer 42 is not secured. In general, regions 45 for fixing a substrate potential, providing electrical isolation for preventing the crosstalk between cells, and having a power supply line for supplying power formed therein are arranged above and below the cell. Therefore, a certain distance 47 between the cell boundary 44 and the diffusion layer 42 can be obtained. More specifically, although a certain distance 48 between the cell boundary 44 and the end portion of the gate wire can be obtained, the end portion of the gate wire cannot be extended more than necessary. That is, it is necessary to perform the sufficient OPC correction to manage the dimensions thereof.

Therefore, after the OPC at the time when the cell is singularly arranged is performed to the patterns on the entire surface of a cell and the cell patterns are registered in a library similar to the first embodiment, cells and patterns are arranged, and the OPC re-correction process for the end portion of the gate wire with taking into account the influence of other cell patterns arranged around the cell is performed.

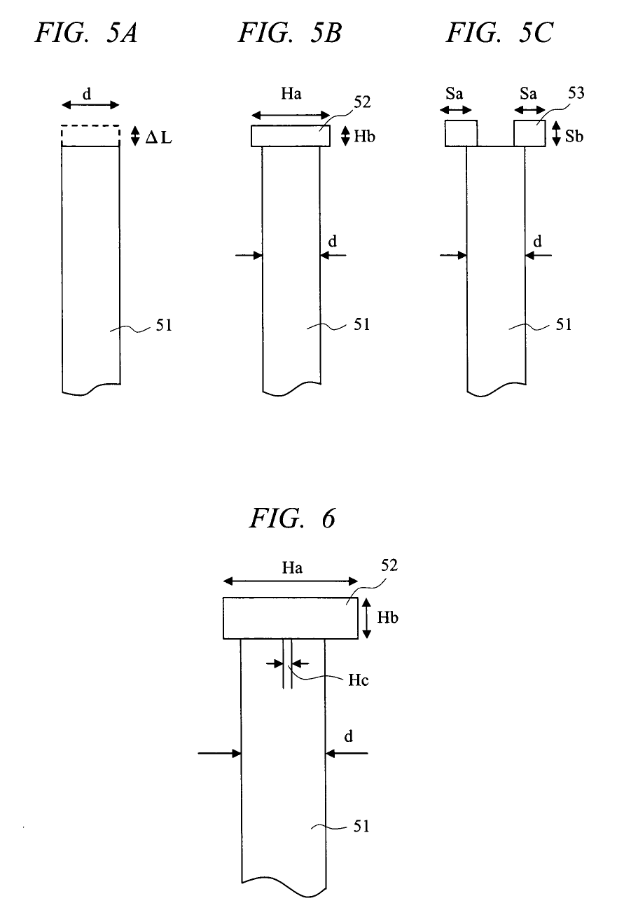

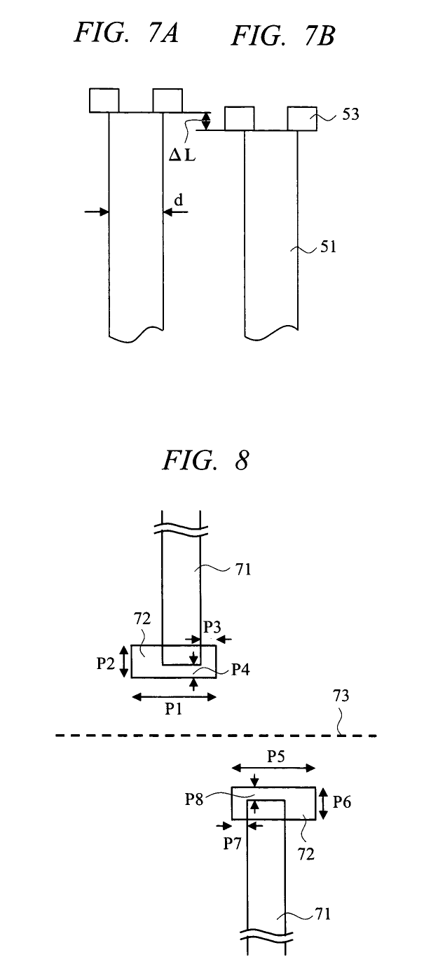

FIG. 5 shows an example of the OPC re-correction process for the end portion of the gate wire. Adjustment variables include a length ΔL of a main pattern 51, a width Ha and a length Hb of a hammer head when a hammer head pattern is used, and a width Sa and a length Sb of a serif when a serif pattern is used. In the case of the hammer head, as shown in FIG. 6, the variables can include a positional error Hc of the hammer head in a width direction d of a main pattern in addition to the width Ha and the length Hb. Also in the case of the serif, a position of the serif can be included in the variables. Furthermore, as shown in FIG. 7, in the case of the serif 53, the length of the main pattern 51 can be also included in the variables. The OPC re-correction is performed by adjusting these variables so that the projecting amount of the gate wire falls within the desired range. Through the process described above, the time required for the OPC performed to the entire surface of the chip can be reduced by about one digit compared with the conventional method.

### Third Embodiment

In this embodiment, an example of the re-correction by OPC for a pattern end portion by using the genetic algorithm will be described based on the correction for a hammer head shape.

An application method of the genetic algorithm will be described below. Since a calculation procedure of the genetic algorithm is the same as that described in the “Summary of the Invention”, details of respective steps will be described here.

### [Initialization: Definition of Chromosome Expression]

In the third embodiment, each variable is handled as a real number directly indicating a size of a figure. That is, respective elements xi (i=1, 2, . . . , 8) in the variable vector X are expressed using real numbers, and they correspond to pi (i=1, 2, . . . , 8) in FIG. 8. At this time, it is possible to adopt a difference from a design target as a chromosome expression instead of a value of the size itself. Alternatively, instead of representing respective elements xᵢ in the variable vector X using real numbers, respective elements xi of the variable vector X may be represented as n-adic numbers by determining an upper limit value, a lower limit value, and the number of quantizing steps.

FIG. 8 shows the case of the hammer head, in which a reference numeral 71 denotes a main pattern and 72 denotes a hammer head. A reference numeral 73 denotes a cell boundary, and the patterns are opposite to each other at the positions slightly shifted from each other. Therefore, unless the hammer heads are displaced to the main patterns, the end portions of the patterns are deformed in a direction approaching to each other. For its prevention, the correction is performed so that the positions of the hammer heads are slightly adjusted based on P3 and P7. Although the number of adjustment variables is large in comparison to the normal hammer head, the OPC re-correction process is performed at high speed by using the genetic algorithm.

In the case of a memory where the same cells are arranged repeatedly and regularly, optimization can be facilitated by grouping all variable vectors of all cells to reduce the length of a chromosome instead of performing optimal value search to all the variable vectors of all the cells.

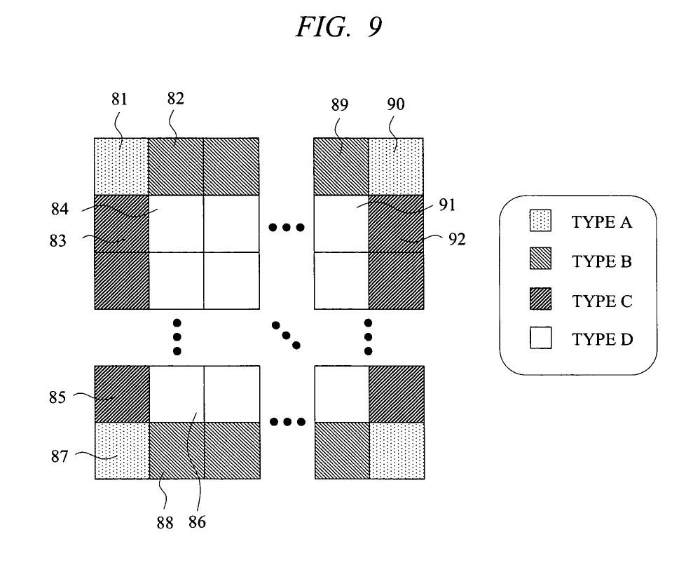

In FIG. 9, for example, when it is assumed that all cells are each constituted of the same kind of figure patterns and the figure is vertically symmetrical and horizontally symmetrical, instead of adopting the variable vectors of all the cells as objects to be optimized, variable vectors of all cells are grouped to four types A to D, and only variable vectors (X¹ X² . . . X⁴) defining the figures of four cells are optimized to apply the result to all the cells for each type. By this means, an effect similar to that obtained by adjusting the whole mask can be obtained.

In FIG. 9, for example, regarding a cell 81, five upper and left side cells of eight surrounding cells are not present and three cells 82, 83, and 84 positioned on right and lower sides of the cell 81 are present. Also, a cell 90 is horizontally symmetrical and a cell 87 is vertically symmetrical to the cell 81 in relationship between themselves and surrounding cells (89, 92, and 91, and 88, 85, and 86). Accordingly, the result of optimization of the cell 81 can be used for the cell 90 and the cell 87. Thus, adjustment process for optimization can be shortened.

### [Initialization: Determination of Evaluation Function]

Since fitness cannot be defined using an explicit function, a procedure of fitness calculation constituted of four steps is adopted as described below.

Step (1): A figure pattern is reconstructed using a variable vector defined from a chromosome uniquely.

Step (2): An optical simulation is performed, and an exposure pattern is calculated. Since a resist pattern can be predicted more accurately by additionally performing the simulation of acid diffusion, accuracy of the optimization can be improved.

Step (3): Regarding the calculated exposure pattern, pattern length and a width of a linear portion of an end portion are measured and a sum of errors from design values is calculated. In particular, when the pattern is the gate wire, since the projecting amount (length) from the diffusion layer influences transistor characteristics as described in the second embodiment, the amount is important.

Step (4): Since a target to be achieved here is to obtain an exposure pattern as close to the design value as possible, smaller errors are more preferable. Therefore, a reciprocal of the measured sum of errors is defined as fitness. Note that, though the reciprocal of the sum of errors is adopted as the fitness, a subtraction value from a predetermined constant value can be adopted as the fitness.

### [Initialization: Generation of Initial Chromosome Population]

A vector constituted of eight real number value elements is here defined as a chromosome according to the rule determined in the above “Initialization: Definition of Chromosome expression”. It is assuming that the number N of chromosomes is 100, and 100 chromosomes are generated at random using a pseudorandom number generator. Note that, in order to improve a search speed, the generation can be started from an initial population obtained by applying slight perturbation to a result corrected by model base OPC.

### [Evaluation of Chromosome]

All chromosomes are evaluated according to the evaluation procedure of chromosome determined in the above “Initialization: Determination of Evaluation Function” and fitness is calculated.

### [Generation of Next-Generation Population: Selection]

In the third embodiment, a roulette selection is used. In this method, a probability that each chromosome can live in the next generation is proportional to its fitness. That is, a chromosome with a higher fitness is arranged in more pockets in the roulette, and a hit probability when the roulette is rotated becomes higher correspondingly. More specifically, when a size of a chromosome population is represented as N, fitness of i-th chromosome is represented as Fi, and a total sum of fitnesses of all the chromosomes is represented as Σ, a procedure for extracting each chromosome with a probability of (Fi+Σ) is repeated N times for the selection. In the above-described case, since the number of chromosomes is 100, 100 next-generation chromosomes are selected by repeating the procedure 100 times. Alternatively, a selection method such as a tournament selection method or rank selection method or a generation alternation model such as an MGG (minimal generation gap) method can be used (Reference: “A New Generation Alternation Model of Genetic Algorithm and Its Assessment” by Sato et al., Journal of Japanese Society for Artificial Intelligence, Vol. 12, No. 5, 1997).

### [Generation of Next-Generation Population: Crossover]

In the third embodiment, a uniform crossover is used. In this method, two chromosomes are selected from chromosome population to make determination whether or not variables which are genes are exchanged in each gene locus at random. More specifically, two selected chromosomes are defined as X¹=(x¹₁, x¹₂) and X²=(x²₁, x²₂) and random number generation for outputting 0 or 1 with a probability of ½ is performed twice. The first random number is directed to the first gene locus and when it is 1, x¹₁ and x²₁, are exchanged, and when it is 0, exchange is not performed. Process to the second gene locus is performed in the same manner. Alternatively, a value obtained by weight-averaging may be used instead of exchanging the gene locus selected at random.

In order to improve a search speed or accuracy, a UNDX (unimodal normal distribution crossover), a simplex crossover, or an EDX (extrapolation-directed crossover) which is the crossover methods developed for a chromosome expressed with real number values, or the like can be used (Reference: “Optimization of non-linear function using real-coded GA: Problem and its Solution in Higher Dimension in Search Space” by Sakuma et al., 15^{th} National Convention of Japanese Society for Artificial Intelligence, 2nd Meeting for Youth MYCOM 2001, 2001).

When a chromosome is expressed using a binary vector, a multi-point crossover may be used besides the uniform crossover.

### [Generation of Next-generation Population: Mutation]

The third embodiment adopts a process where a random number generated according to a normal distribution is added to a gene locus selected at a mutation rate P_{M}. In this case, the mutation rate P_{M}, an average u of the normal distribution, and the standard deviation σ are set to 1/50, 0, and 5×10⁹, respectively.

### [Termination Condition of Search]

When an error from a design value becomes zero or when the number of evaluations of chromosome reaches a predetermined times or more, the search is terminated. In the third embodiment, the search is terminated when an error from a design value becomes zero or evaluation of chromosome has been performed 5000 times. Mutation using random numbers generated according to a normal distribution is used. In order to improve a search speed or accuracy, it is possible to use an adaptive mutation method, in which an improvement speed of fitness of a whole population is monitored and a mutation rate is temporarily increased when the fitness is not improved for a certain time period or more.

The genetic algorithm used in the third embodiment has been described above. Moreover, the search speed and the accuracy can be improved by using other search methods such as a hill-climbing search, a simplex method, a steepest descent method, a simulated annealing, and a dynamic programming method. A further search speed improvement and accuracy improvement can be realized by selectively using other blind search technique and a probabilistic search technique such as an evolution strategy (ES) and a genetic programming (GP) in addition to the genetic algorithm.

As described above, since a semiconductor chip is produced using a cell library on which OPC process has been performed in advance and the influence of surrounding cell libraries is optimized utilizing the genetic algorithm which can perform the high speed process, a processing time can be reduced by one digit or more as compared with the conventional method that performs OPC process to all the patterns.

In the third embodiment, the case of the hammer head has been described. Also in the case of the serif, the OPC re-correction by independently changing the serif positions can be performed in the same manner. The number of variables is increased in the case of the serif in comparison to the case of the hammer head, and the number of variables is further increased when the positions of the serifs are independently changed. However, the operation can be performed at high speed when the genetic algorithm is used.

### Fourth Embodiment

A system LSI having an SRAM portion and a logic circuit portion is manufactured using the mask pattern designing method described in the first embodiment. The minimum gate width of the system LSI is 40 nm, and the minimum pitch is 160 nm. The logic circuit portion allows arbitrary pitch wiring and does not require any arrangement restriction except for the minimum interval between cells. Therefore, the conventional IP can be inherited, high expansion property can be obtained as a platform, and a layout rule applicable to various kinds is provided.

When a correction pattern for the size is produced by a rule base OPC under the loose layout rule described above, a portion where the projection of a gate wire from the diffusion layer is insufficient is formed, which deteriorates the transistor characteristics. Also, there is such a problem that an exposure margin to exposure amount fluctuation or focus fluctuation is small and a yield as a semiconductor device is low. Further, it takes such a long time period as 7 days when a mask producing pattern is produced using a commercially available model base OPC.

Since the system LSI is directed to a specific user and a product cycle thereof is short, it must be manufactured for a short time period. The time period is the lifeline and it influences not only a value of the system LSI as a device but also marketability of a product incorporating the system LSI. When preferentially performed utilizing single-wafer process, a wafer process term requires at least two weeks, which is considered as prompt mask supply. In order to achieve the producing period of a mask producing pattern as short as practical one day, a rule base must be partially applied in the conventional method, which causes such a problem as yield degradation as described above. When the mask pattern producing method described in the first embodiment is applied, a time required for mask pattern production is only one day, and device properties and yield equivalent to those in full application of the model base can be obtained. By applying the single-wafer process to the wafer process, a wafer process waiting time can be reduced and proper balance with a mask supplying rate can be achieved. As a result, shipping timing of the system LSI is accelerated.

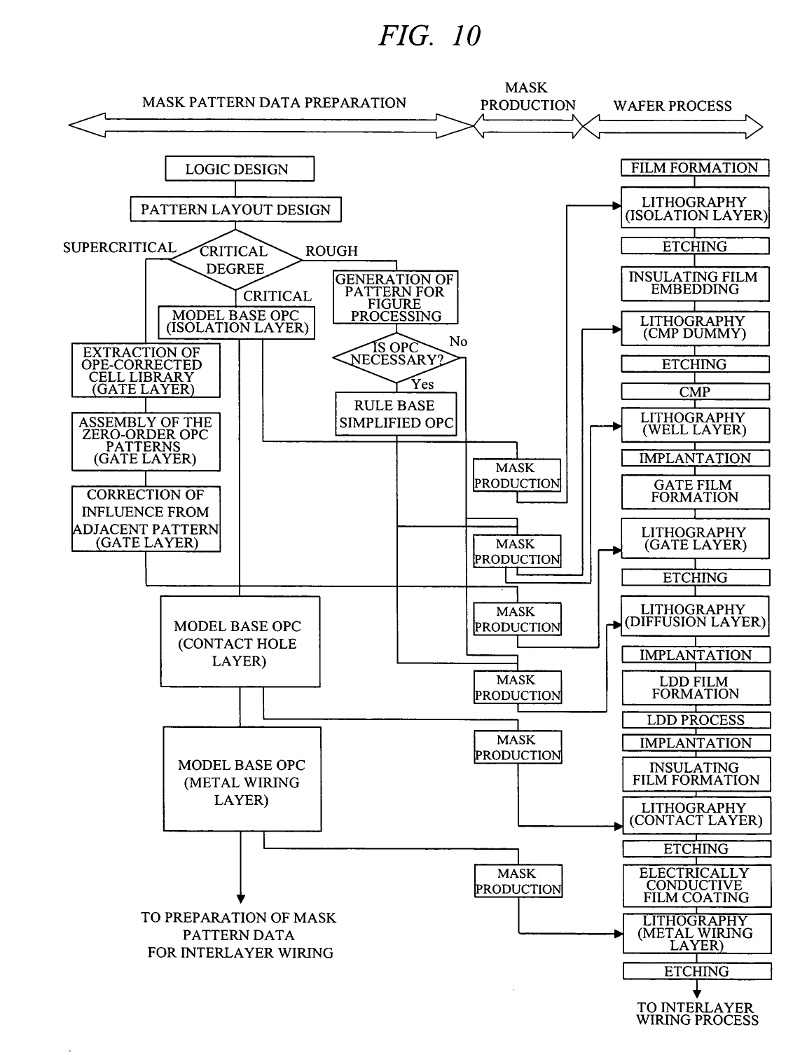

The above-described aspect will be described with reference to FIG. 10. FIG. 10 is a flowchart showing a mask pattern data preparation step, a mask producing step, and a wafer processing step for a system LSI. In FIG. 10, the mask pattern data preparation step is shown on the left side, the mask producing step is shown on the central side, and the wafer processing step and timings are shown on the right side.

When a pattern layout design based on a logic design is terminated, manufacture of an LSI is started. A wafer process flow includes a film formation for producing isolation (isolation between active regions), lithography, etching, insulating film embedding, lithography for CMP dummy pattern production for performing further planarization, etching, and CMP, and thus, the isolation is formed. Thereafter, lithography for selective implantation, formation of a well layer through implantation, film formation for a gate, lithography, etching, lithography for selective implantation, implantation, film formation for LDD, LDD processing, and implantation are performed to form a gate. Then, after an insulating film is formed, via holes are formed by performing lithography for contact hole and etching, and subsequently, a wiring layer is formed by performing lithography and etching after formation of an electrically conductive film. Then, though not illustrated, after an interlayer insulating film and openings are formed, an electrically conductive film is coated thereon, and interlayer wires are formed through CMP.

Masks have to be prepared so as to correspond to the wafer process flow. The masks are roughly classified into a mask for a critical layer which requires high dimensional accuracy and a mask for a non-critical layer. The former mask requires OPC with an enormous amount of data but the latter mask only requires simplified OPC, a simple figure calculation, or data itself. Typical critical layer includes isolation, a gate, a contact, and first and second wires. Among them, the gate is a supercritical layer because the required dimensional accuracy thereof is particularly high.

After the determination whether mask pattern OPC data corresponds to the critical layer or the supercritical layer, a manufacturing procedure is started. In this case, the present invention described in the first embodiment is applied to the gate layer which is the supercritical layer in which a particularly high dimensional accuracy is required. First, matching patterns are extracted from a cell library for OPE (Optical Proximity Effect) correction prepared in advance and the zero-order OPE-processed pattern is assembled by combining the matching patterns. Then, correction taking into account the influence from an adjacent pattern is performed based upon the genetic algorithm technique in the third embodiment to produce a final OPC pattern, and a mask is produced based upon the data thereof.

The process before the next lithography for a gate layer includes 9 steps in the rough classification, and it includes about 50 steps (not shown) if sub-steps such as a cleaning step are included. However, the process can be completed in two days by utilizing the single-wafer process. If a mask for a gate layer is not prepared during this period, loss due to waiting occurs. Since the gate requires very high dimensional accuracy, a time period of about one day is required for mask writing and its inspection. In the fourth embodiment, the mask pattern data can be prepared in only one day though the preparation requires 7 days in the conventional method. If it requires 7 days for the preparation of the mask pattern data, it is impossible to catch up with a speed of the wafer processing even when pattern data preparation equipment is enlarged to start the data preparation in parallel with the isolation pattern production. In the method of the present invention, high-speed process corresponding to a speed of the single-wafer process can be performed utilizing relatively small-sized pattern data preparation equipment, and the system LSIs can be manufactured early.

Since the gate pattern requires a high dimensional accuracy, it is difficult to sufficiently acquire device properties by the rule base. However, since a complicated process is required in the mode base, a problem that a large amount of time is required for the pattern production appears more strongly than that in other layers. Accordingly, the present method is effective particularly for the gate pattern preparation.

Since the conventional OPC process is performed to all figures of a mask defining a circuit pattern of a semiconductor chip, it has such a drawback that a processing time becomes enormous due to increase of the number of figures according to miniaturization. According to the first to fourth embodiments described above, however, after OPC process is performed to each of the cells and the processed cells are stored, all figures of a mask are constituted of the combinations of the stored cells, and then the OPC adjustment process between cells is performed to all the figures of the mask. In this manner, the processing time can be significantly reduced.

The reason why the processing time can be reduced is as follows. That is, since the OPC process for each cell is stored as a library in advance and the library is used between products in common, an OPC processing time for each of products is substantially occupied by the OPC process between cells, and the number of combinations (the number of parameters) is significantly reduced as compared with the case where the OPC process is performed to all figures of a mask. As a result, a converging time to the optimization thereof is remarkably reduced.

Also, since the mask pattern design for a large scale integrated circuit in a manufacturing method of a semiconductor device can be hastened and facilitated by utilizing the mask pattern designing method and the designing apparatus using the optical proximity correction of optical lithography according to the first to fourth embodiments, such a significant effect that mask patterns can be produced in a short time and at low cost can be achieved.

Accordingly, the large scale integrated circuit can be efficiently produced and occurrence of such a failure as disconnection in a manufactured large scale integrated circuit can be reduced. Therefore, reliability is improved and yield thereof is also improved. Further, since the design time of a mask pattern is reduced by about one digit as compared with the conventional design time, such an advantage can be obtained that cost reduction of custom IC using a large number of mask patterns can be achieved and industrial applicability thereof can be expanded. For example, development of system LSI for digital home information appliances obtained through the high-mix low-volume production can be achieved at low cost.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be utilized in the field of manufacturing a semiconductor device, electronic appliances, and the like.

What is claimed is:

1. A mask pattern designing method comprising the steps of:
(a) performing first optical proximity correction performed as a result of pattern transfer formation at the time when a cell is singularly arranged and registering a cell group thereof in a cell library;
(b) arranging a plurality of cells using said cell library; and
(c) performing second optical proximity correction for correcting pattern deformation occurring from mutual interference between patterns due to proximate arrangement of said plurality of cells,
wherein, in said step (c), a portion where a pattern deformation due to the proximate arrangement of the cells is corrected is an end portion of a pattern at a periphery portion of said cell.

2. A mask pattern designing method comprising the steps of:
(b1) arranging a plurality of cells by using a cell library where a cell group to which first optical proximity correction is performed as a result of pattern transfer formation at the time when a cell is singularly arranged has been registered; and
(c) performing second optical proximity correction for correcting pattern deformation occurring from mutual interference between patterns due to proximate arrangement of said plurality of cells,
wherein, in said step (c), a portion where a pattern deformation due to the proximate arrangement of the cells is corrected is an end portion of a pattern at a periphery portion of said cell.

3. A mask pattern designing method comprising the steps of:
(c1) for a pattern obtained by arranging a plurality of cells by using a cell library where a cell group to which first optical proximity correction is performed as a result of pattern transfer formation at the time when a cell is singularly arranged has been registered, performing second optical proximity correction for correcting pattern deformation occurring from mutual interference between patterns due to proximate arrangement of said plurality of cells,
wherein, in said step (c1), a portion where a pattern deformation due to the proximate arrangement of the cells is corrected is an end portion of a pattern at a periphery portion of said cell.

4. The mask pattern designing method according to claim 1,
wherein said end portion of a pattern has a rectangular shape, and
said portion where a pattern deformation is corrected is a length of a wire.

5. The mask pattern designing method according to claim 1,
wherein said end portion of a pattern has a hammer-head shape, and
said portion where a pattern deformation is corrected is a length and a width of said hammer head.

6. The mask pattern designing method according to claim 1,
wherein said end portion of a pattern has a hammer-head shape, and
said portion where a pattern deformation is corrected is a length and a width of said hammer head and the amount of positional shift of said hammer head in a direction of said width.

7. The mask pattern designing method according to claim 1,
wherein said end portion of a pattern has a shape provided with serifs, and
said portion where a pattern deformation is corrected is a length and a width of said serifs.

8. The mask pattern designing method according to claim 1,
wherein said end portion of a pattern has a shape provided with serifs added to a linear portion, and
said portion where a pattern deformation is corrected is a length and a width of said serifs and the amount of positional shift of said serifs in a direction of said width.

9. The mask pattern designing method according to claim 1,
wherein said end portion of a pattern has a shape provided with serifs added to a linear portion, and
said portion where a pattern deformation is corrected is a length of said linear portion.

10. The mask pattern designing method according to claim 1,
wherein said portion where a pattern deformation is corrected is an end portion of a pattern located in a region within a 0.85 times the minimum gate wiring pitch interposing a contact hole from a boundary between said cell and outside.

11. The mask pattern designing method according to claim 1,
wherein a genetic algorithm is used for said second optical proximity correction.

12. The mask pattern designing method according to claim 4,
wherein said portion where a pattern deformation is corrected is registered in said cell library.

13. A method for manufacturing a semiconductor device using a mask produced through the process comprising the steps of:
(a) performing first optical proximity correction performed as a result of pattern transfer formation at the time when a cell is singularly arranged and registering a cell group thereof in a cell library;
(b) arranging a plurality of cells using said cell library; and
(c) performing second optical proximity correction for correcting pattern deformation occurring from mutual interference between patterns due to proximate arrangement of said plurality of cells,
wherein, in said step (c), a portion where a pattern deformation due to the proximate arrangement of the cells is corrected is an end portion of a pattern at a periphery portion of said cell.

14. A method for manufacturing a semiconductor device using a mask produced through the process comprising the steps of:
(b1) arranging a plurality of cells by using a cell library where a cell group to which first optical proximity correction is performed as a result of pattern transfer formation at the time when a cell is singularly arranged has been registered; and
(c) performing second optical proximity correction for correcting pattern deformation occurring from mutual interference between patterns due to proximate arrangement of said plurality of cells,
wherein, in said step (c), a portion where a pattern deformation due to the proximate arrangement of the cells is corrected is an end portion of a pattern at a periphery portion of said cell.

15. A method for manufacturing a semiconductor device using a mask produced through the process comprising the steps of:
(c1) for a pattern obtained by arranging a plurality of cells by using a cell library where a cell group to which first optical proximity correction is performed as a result of pattern transfer formation at the time when a cell is singularly arranged has been registered, performing second optical proximity correction for correcting pattern deformation occurring from mutual interference between patterns due to proximate arrangement of said plurality of cells,
wherein, in said step (c1), a portion where a pattern deformation due to the proximate arrangement of the cells is corrected is an end portion of a pattern at a periphery portion of said cell.

16. The method for manufacturing a semiconductor device according to claim 15,
wherein said pattern is a patter of a gate wire.

17. The method for manufacturing a semiconductor device according to claim 16,
wherein said portion where a pattern deformation is corrected is an end portion of the wire located at a position closer to a cell boundary than a diffusion layer.
